(19) United States
(12) Patent Application Publication
(10) Pub. No.: US 2006/0059438 A1
(43) Pub. Date: Mar. 16, 2006

(54) Optical reproducing apparatus and method capable of adjusting size of OSD menu

(75) Inventors: Charm-han Ko, Hwaseong-si (KR); Se-hee Kang, Suwon-si (KR); Kang-heuy Lee, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/222,968

(22) Filed: Sep. 12, 2005

(30) Foreign Application Priority Data
Sep. 14, 2004 (KR) 10-2004-0073243

(51) Int. Cl. G06F 3/00

(52) U.S. Cl. 715/800; 715/815

(57) ABSTRACT

An optical reproducing apparatus and method capable of adjusting a size of a menu view. An user input unit selects a predetermined menu view mode among a plurality of menu view modes displaying a standard menu view in different sizes. A storage stores an image information of the standard menu view corresponding to a standard mode among the plurality of the menu view modes. A menu view generator generates a menu view corresponding to the predetermined menu view mode selected by the user input unit based on the stored image information. An output unit outputs the generated menu view to a display device being connected. A controller controls the menu view generator to adjust a size of the standard menu view based on the image information if the selected menu view mode is one of an enlargement mode or a reduction mode. Accordingly, it is possible to adjust the size of the menu view in consideration of the screen size of the display device.

### CROSS-REFERENCE TO RELATED APPLICATIONS

This application claims the benefit under 35 U.S.C. § 119(a) from Korean Patent Application No. 2004-73243 filed on Sep. 14, 2004 in the Korean Intellectual Property Office, the entire disclosure of which is incorporated herein by reference.

### BACKGROUND OF THE INVENTION

1. Field of the Invention

The present invention relates generally to an optical reproducing apparatus and method capable of adjusting a size of a menu view. More specifically, the present invention relates to an optical reproducing apparatus and method capable of adjusting a size of a menu view in consideration of a screen size of a display device.

2. Description of the Related Art

An optical reproducing apparatus records data on an optical disc, or reproduces data that is recorded on the optical disc. The optical reproducing apparatus, such as a DVDP (digital video disc player), can provide video with high definition and high resolution.

The optical reproducing apparatus supports a menu view allowing a user to set various functions of the optical reproducing apparatus. The menu view is displayed on a television connected to the optical reproducing apparatus, and is implemented as an OSD (on-screen display) or a GUI (graphic user interface).

Any TV screen connected to the optical reproducing apparatus has the same number of pixels regardless of the screen size. Accordingly, a large-sized TV has the same number of pixels as a small-sized TV, and thus, implements a large screen by enlarging the pixel size of video.

A conventional optical reproducing apparatus outputs to the TV a menu view of the same number of pixels regardless of the size of the TV screen. As a result, the size of the menu provided from the optical reproducing apparatus is enlarged in proportion to the larger TV screen. Such a menu view is likely to conceal considerable areas of the screen of the large-sized TV compared with the small-sized TV. When the user displays the menu view while watching video on the TV screen, the menu view overlaps many areas of the TV screen and causes inconvenience and discomfort to the user while watching the TV.

### SUMMARY OF THE INVENTION

The present invention has been developed in order to solve the problems discussed above and others associated with the conventional arrangement. An aspect of the present invention provides an optical reproducing apparatus and method capable of adjusting a size of a menu view so that a user can change the size of the menu view to a desired size.

The foregoing and/or other aspects of the present invention are achieved by providing an optical reproducing apparatus capable of adjusting a size of a menu view, including a user input unit to select a certain menu view mode among a plurality of menu view modes displaying a standard menu view in different sizes, a storage to store an image information of the standard menu view corresponding to a standard mode among the plurality of the menu view modes, a menu view generator to generate a menu view corresponding to the certain menu view mode selected by the user input unit based on the stored image information, an output unit to output the generated menu view to a display device, and a controller to control the menu view generator to adjust a size of the standard menu view based on the image information if the selected menu view mode is at least one of an enlargement mode and/or a reduction mode.

The controller controls the menu view generator to enlarge the size of the standard menu view by increasing a number of pixels of the standard menu view in at least one of a horizontal direction and/or a vertical direction if the selected menu view mode is the enlargement mode.

The controller controls the menu view generator to reduce the size of the standard menu view by decreasing a number of pixels of the standard menu view in at least one of the horizontal direction and/or the vertical direction if the selected menu view mode is the reduction mode. The image information contains the number of pixels of the standard menu view and a font that is set corresponding to the standard menu view.

The optical reproducing apparatus further includes an optical disc drive to detect data recorded on an optical disc by irradiating a light on the optical disc, a digital signal processor to digitize the detected data, and a reproduction processor to process the digitized data into a reproducible signal and output the reproducible signal to the output unit. The controller controls the reproduction processor to overlap and output to the output unit the menu view generated in the menu view generator over a video signal included in the reproducible signal.

Another aspect of the present invention is achieved by providing an optical reproducing method capable of adjusting a size of a menu view, including storing an image information of a standard menu view, selecting by a user interface a certain menu view mode among a plurality of menu view modes displaying the standard menu view in different sizes, generating a menu view corresponding to the selected menu view mode, if the selected menu view mode is at least one of an enlargement mode and/or a reduction mode, by adjusting a size of the standard menu view based on the stored image information, and outputting the generated menu view to a display device being connected.

The optical reproducing method enlarges the size of the standard menu view by increasing a number of pixels of the standard menu view in at least one of a horizontal direction and/or a vertical direction if the selected menu view mode is the enlargement mode. The optical reproducing method reduces the size of the standard menu view by decreasing the number of pixels of the standard menu view in at least one of the horizontal direction and/or the vertical direction if the selected menu view mode is the reduction mode. The image information contains the number of pixels of the standard menu view and a font that is set corresponding to the standard menu view.

The optical reproducing method further includes, data recorded on an optical disc by irradiating a light on the optical disc, digitizing the detected data; processing the digitized data into a reproducible signal, and overlapping the generated menu view over a video signal included in the reproducible signal, and outputting the generated menu view.

Another aspect of the present invention is achieved by providing an optical reproducing method, including generating a menu view corresponding to a selected menu view mode, if the selected menu view mode is at least one of an enlargement mode and/or a reduction mode, by adjusting a size of a standard menu view based on corresponding stored image information.

### BRIEF DESCRIPTION OF THE DRAWINGS

These and/or other aspects and advantages of the invention will become apparent and more readily appreciated from the following description of the embodiments, taken in conjunction with the accompanying drawing figures of which:

FIG. 1 is an example illustrating a conventional menu view displayed on a display device;

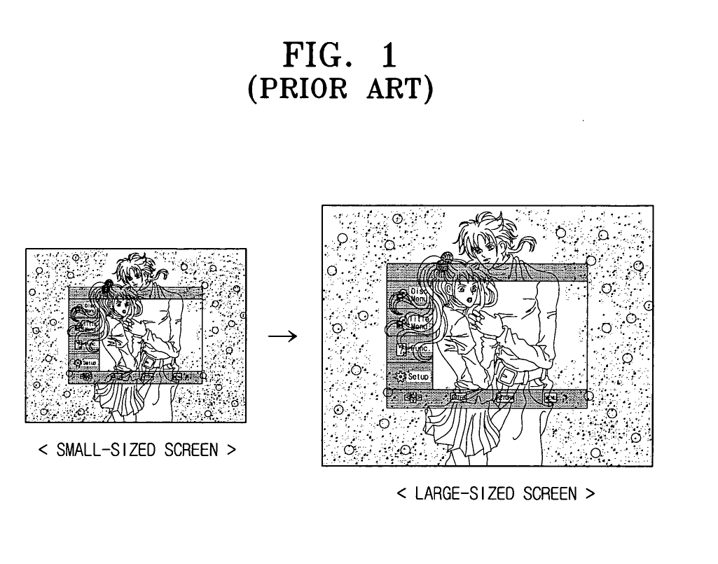

FIG. 2 is a block diagram illustrating an optical reproducing apparatus capable of adjusting a size of a menu view according to an embodiment of the present invention;

FIG. 3 is an example illustrating a mode selection view generated by the optical reproducing apparatus of FIG. 2;

FIGS. 4A to 4C are examples illustrating a menu view displayed according to a menu view mode selected by the optical reproducing apparatus and a size of a display device;

FIG. 5 is a flowchart illustrating an optical reproducing method of the optical reproducing apparatus of FIG. 2.

FIGS. 6A to 6C are examples illustrating the menu view displayed according to the menu view modes when the optical reproducing apparatus is connected to the display device having a small-sized screen; and

FIGS. 7A and 7B are examples illustrating the menu view displayed according to the menu view modes when the optical reproducing apparatus is connected to the display device having a large-sized screen.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the drawings.

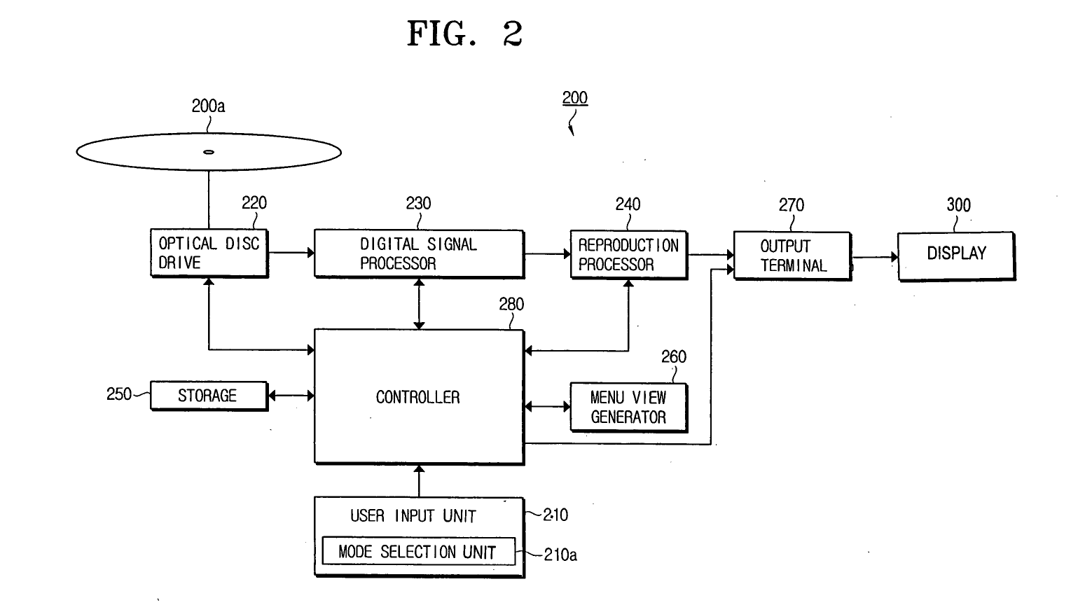

FIG. 2 is a block diagram of an optical reproducing apparatus capable of adjusting a size of a menu view according to an embodiment of the present invention.

Referring to FIG. 2, the optical reproducing apparatus 200 includes a user input unit 210, an optical disc drive 220, a digital signal processor 230, a reproduction processor 240, a storage 250, a menu view generator 260, an output terminal 270, and a controller 280.

The optical reproducing apparatus 200 is a data processing apparatus that processes motion pictures and/or still images recorded on the optical disc 200a into a reproducible signal, and provides the reproducible signal to a display device 300. Examples of the optical reproducing apparatus 200 include a DVDP (digital video disc player) and a DVDR (digital video disc recorder). The example of the optical disc 200a includes at least one of a DVD, a VCD (video compact disc), and/or a CD.

The user input unit 210 is a user interface to output to the controller 280 a command for setting or executing a function supported by the optical reproducing apparatus 200. To this end, the user input unit 210 is provided with a plurality of operation keys such as number keys, direction keys, and an OK key.

According to an embodiment of the present invention, the user input unit 210 includes a mode selection unit 210a for selecting a certain menu view mode from a plurality of menu view modes having different sizes provided from the optical reproducing apparatus 200. The menu view mode is to display the menu view of different sizes by adjusting the number of pixels of the menu view according to the user's selection. The menu view allows the user to select or set various functions of the optical reproducing apparatus 200, or to indicate a current state of the optical reproducing apparatus 200.

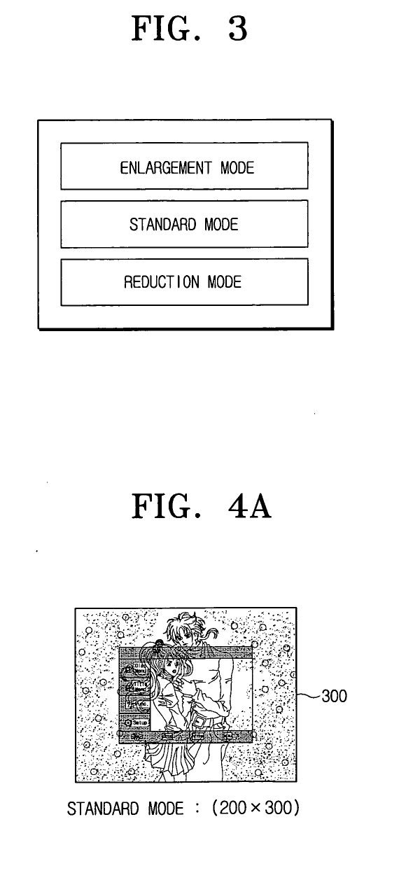

When the mode selection unit 210a is selected, the menu view generator 260, to be explained below, generates a mode selection view as shown in FIG. 3. The generated mode selection view is displayed on the display device 300 via the reproduction processor 240 and the output terminal 270.

Referring to FIG. 3, the plurality of the menu view modes includes an enlargement mode, a standard mode, and a reduction mode. The menu view modes may be classed into more specific modes. The enlargement mode magnifies a standard menu view corresponding to the standard mode, and the reduction mode minimizes the standard menu view.

The optical disc drive 220 detects data recorded on the optical disc 200a by scanning the optical disc 200a by a beam. Specifically, a pickup device (not shown) of the optical disc drive 220 aims the beam at the optical disc 200a and detects an RF signal from the optical disc 200a. An RF amplifier (not shown) of the optical disc drive 220 amplifies the RF signal output from the pickup device (not shown), converts the amplified signal into an electric signal, and outputs a servo signal for a servo motor. A servo unit (not shown) of the optical disc drive 220 receives information required for the servo motor from the RF amplifier (not shown) and the controller 280, and then controls the servo motor. The digital signal processor 230 digitizes the data detected by the optical disc drive 220. The reproduction processor 240 decompresses the signal (for example, motion picture data) input from the digital signal processor 230, and processes the decompressed signal into a reproducible signal. The reproduction processor 240 outputs a main image such as a motion picture together with an overlapped sub-image such as a subtitle and the menu view generated in the menu view generator 260.

The storage 250 stores image information on the standard menu view corresponding to the standard mode among the plurality of the menu views of the different sizes. The image information contains a bitmap image, font data, and the number of pixels on the standard menu view, which are required for the display of the menu view. Advantageously, the plurality of the menu views provided from the optical reproducing apparatus 200 may have the same or a different number of pixels.

The menu view generator 260 generates the menu view allowing the user to select or set various functions supported by the optical reproducing apparatus 200, or indicating the current state of the optical reproducing apparatus 200. For example, when the mode selection unit 210a of the user input unit 210 is selected, the menu view generator 260 generates the mode selection view as shown in FIG. 3. The generated mode selection view is displayed on the display device 300 via the reproduction processor 240 and the output terminal 270. The mode selection view indicates the plurality of the menu view modes providing different view sizes. When a certain menu view mode is selected in the displayed mode selection view by the user input unit 210, the menu view generator 260 generates a menu view corresponding to the selected menu view mode based on the image information stored in the storage 250.

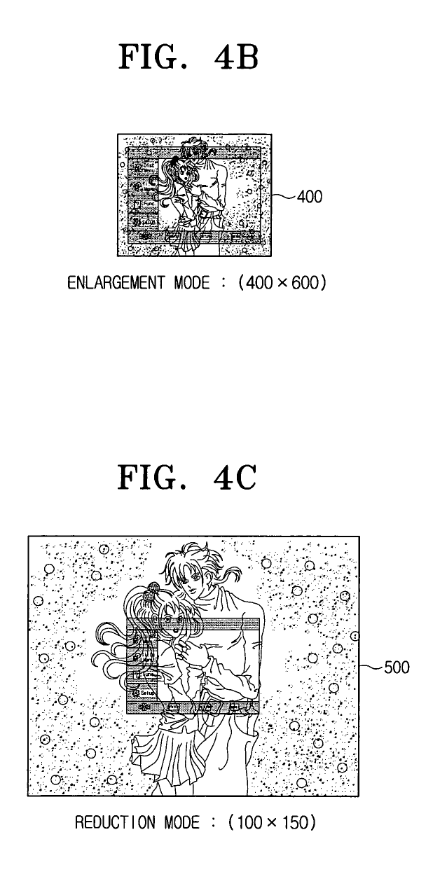

Further, if the standard mode is selected by the user input unit 210, the menu view generator 260 generates a menu view by using the image information of the menu view stored in the storage 250. For instance, if the image information of a certain menu view indicates 200×300 pixels, the menu view generator 260 generates the menu view of 200×300 as shown in FIG. 4A.

If the enlargement mode is selected by the user input unit 210, the menu view generator 260 magnifies the size of the standard menu view, and thus, generates a certain menu view based on the image information of the certain menu view stored in the storage 250. That is, the menu view generator 260 magnifies the standard menu view by increasing the number of pixels of the standard menu view in at least one of a horizontal direction and/or a vertical direction.

For example, with the optical reproducing apparatus 200 connected to a display device 400 having a screen smaller than that of the display device 300 of FIG. 4A, the enlargement mode magnifying in both the horizontal direction and the vertical direction is set, and the image information of a certain menu view indicates 200×300 pixels. In this situation, the menu view generator 260 generates a menu view having 400×600 pixels as shown in FIG. 4B. Since the display device 400 has the screen smaller than that of the display device 300 of FIG. 4A, the menu view on the display device 400 has 400×600 pixels but the size of each pixel is reduced. When the magnification is set only in the horizontal direction and the image information of a certain menu view indicates 200×300 pixels, the menu view generator 260 generates a menu view of 400×300. When the reduction mode is set by the user input unit 210, the menu view generator 260 reduces the size of the standard menu view for a certain menu view based on the image information of the certain menu view stored in the storage 250. Specifically, the menu view generator 260 minimizes the standard menu view by decreasing the number of pixels of the standard menu view in at least one of the horizontal direction and/or the vertical direction.

For example, with the optical reproducing apparatus 200 connected to a display device 500 of FIG. 4C having a screen larger than the screen of the display device 300 of FIG. 4A, and the optical reproducing apparatus 200 is set to reduce in both the horizontal direction and the vertical direction, the image information of a certain menu view indicates 200×300 pixels. In this situation, the menu view generator 260 generates a menu view having 100×150 pixels as shown in FIG. 4C. As the display device 500 has the screen larger than that of the display device 300 of FIG. 4A, the menu view on the display device 500 has 100×150 pixels but the size of each pixel is enlarged.

The menu view is implemented as an OSD (on-screen display) or a GUI (graphic user interface). The generated menu view is supplied to the reproduction processor 240, and overlapped on the motion picture data or separately outputted to the output terminal 270. The output terminal 270, which is employed as an output unit, sends to the display device 300 at least one of the motion picture data and/or the menu screen both of which are being outputted from the reproduction processor 240. The motion picture data and/or and the menu view are displayed on the display device 300. A transmission cable (not shown) connects the output terminal 270 and the display device 300.

The controller 280 controls the overall operations of the optical reproducing apparatus 200 according to a signal generated from the user input unit 210 or the remote controller (not shown) and a pre-stored control program.

According to an embodiment of the present invention, the controller 280, upon receiving a mode selection signal from the user input unit 210, controls the menu view generator 260, the reproduction processor 240 and the output terminal 270 so as to generate and output the mode selection view to the display device 300 as shown in FIG. 3.

After the mode selection view is displayed on the display device 300, if one of the enlargement mode and the reduction mode is selected by the user input unit 210, the controller 280 controls the menu view generator 260 to magnify or minimize the size of the standard menu view stored in the storage 250.

If the enlargement mode is selected, the controller 280 controls the menu view generator 260 to magnify the standard menu view by increasing the number of pixels of the standard menu view in at least one of the horizontal direction and/or the vertical direction.

If the reduction mode is selected, the controller 280 controls the menu view generator 260 to minimize the standard menu view by decreasing the number of pixels of the standard menu view in at least one of the horizontal direction and/or the vertical direction.

If the data recorded on the optical disc 200a is reproduced and outputted to the display device 300 during the above operation, the controller 280 controls the reproduction processor 240 to overlap and output to the output terminal 270 the menu view generated in the menu view generator 260 over the reproducing data.

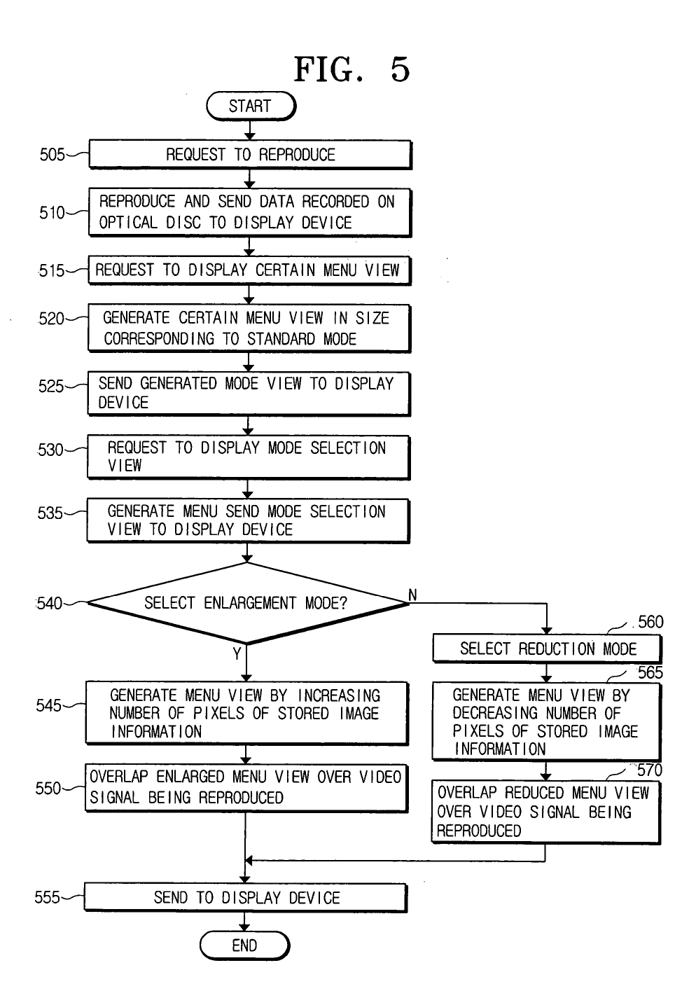

FIG. 5 is a flowchart of an optical reproducing method of the optical reproducing apparatus of FIG. 2.

When it is requested from the user input unit 210 to reproduce the data recorded on the optical disc 200a as in operation 505, the controller 280 controls the optical disc drive 220, the reproduction processor 240, and the output terminal 270 to load, process and reproduce the optical disc 200a, and send the data to the display device 300 in operation 510. Video and audio signals of the data recorded on the optical disc 200a are outputted to the display device 300 to be displayed.

Next, in operation 515, when the display request signal for a certain menu view is received from the user input unit 210, the controller 280 controls the menu view generator 260 to generate the certain menu view corresponding to the size of the standard mode in operation 520. The menu view generator 260 generates the menu view having the size of the standard menu view using the image information of the certain menu view stored in the storage 250. The following explains, for example, a case when the size of the standard menu view is 200×300.

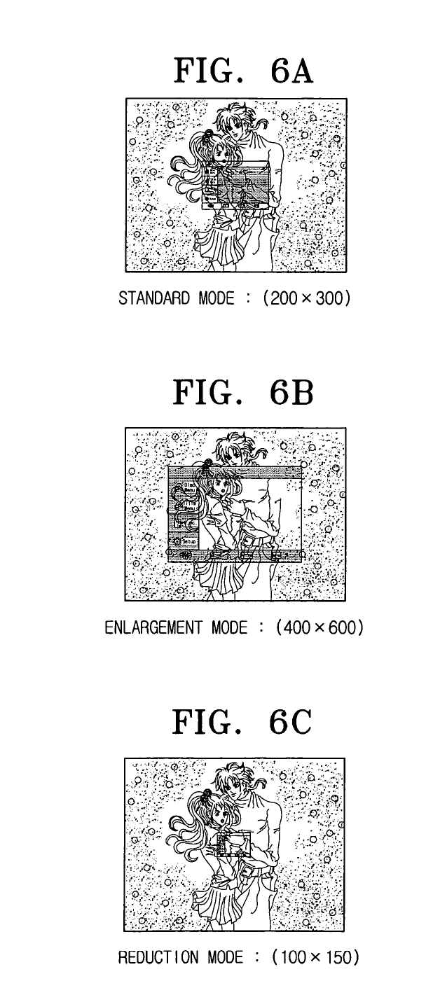

In operation 525, the controller 280 controls the output terminal 270 to send the generated menu view to the display device. If the display device 400 as illustrated in FIG. 4B has a small-sized screen, the generated menu view in operation 520 is minimized and displayed on the display device as shown in FIG. 6A. Since the screen of the display device is smaller, the number of pixels of the menu view is maintained but the size of each pixel is reduced. Therefore, the user experiences discomfort in noticing the displayed menu view of 200×300 and requests to magnify the menu view.

When the display request signal for the mode selection view is received from the mode selection unit 210a by the user n operation 530, the controller 280 controls the menu view generator 260, the reproduction processor 240, and the output terminal 270 to generate and send the mode selection view to the display device 300 in operation 535.

When the mode selection view is displayed as shown in FIG. 3, if the enlargement mode is selected from the user input unit 210 in operation 540, the controller 280 controls the menu view generator 260 to magnify the certain menu view based on the image information of the certain menu view stored in the storage 250 in operation 545. Specifically, the controller 280 controls the menu view generator 260 to magnify the standard menu view by increasing the number of pixels among the image information of the certain menu view in at least one of the horizontal direction and/or the vertical direction. According to an embodiment of the present invention, the menu view generator 260 doubles both the horizontal direction and the vertical direction, and thus generates the menu view of 400×600.

After operation 545, the controller 280 controls the reproduction processor 240 and the output terminal 270 to overlap the magnified menu view over the reproducing video signal and send the reproducible signal to the display device 300 in operations 550 and 555. Therefore, the display device 300 of the smaller screen displays the enlarged menu view of 6B, and the user notices the menu view relatively easier than the menu view of FIG. 6A.

In operation 560, if the reduction mode is selected from the user input unit 210 after the display of the mode selection view as shown in FIG. 3 (S560), the controller 280 controls the menu view generator 260 to minimize the certain menu view based on the image information of the certain menu view stored in the storage 250 in operation 565. Specifically, the controller 280 controls the menu view generator 260 to minimize the standard menu view by decreasing the number of pixels among the image information of the certain menu view in at least one of the horizontal direction and/or the vertical direction. According to an embodiment of the present invention, the menu view generator 260 is reduced by a factor of 2 in both the horizontal direction and the vertical direction, and thus, generates the menu view of 100×150.

Next, in operations 570 and 555, the controller 280 controls the reproduction processor 240 and the output terminal 270 to overlap the reduced menu view over the reproducing video signal and sends the signal to the display device 300. Therefore, the display device 300 of the small screen displays the minimized menu view shown in FIG. 6C as compared with the menu view of FIG. 6A.

According to an embodiment of the present invention, the user can change the size of the menu view according to the screen size of the display device 300 that is connected to the optical reproducing apparatus 200.

If the display device 300 with the small-sized screen is connected to the optical reproducing apparatus 200 and the menu view is displayed small as shown in FIG. 6A, the user can magnify the menu view by using the enlargement mode as shown in FIG. 6B. Therefore, the user is able to observe the menu view with relative ease and comfort.

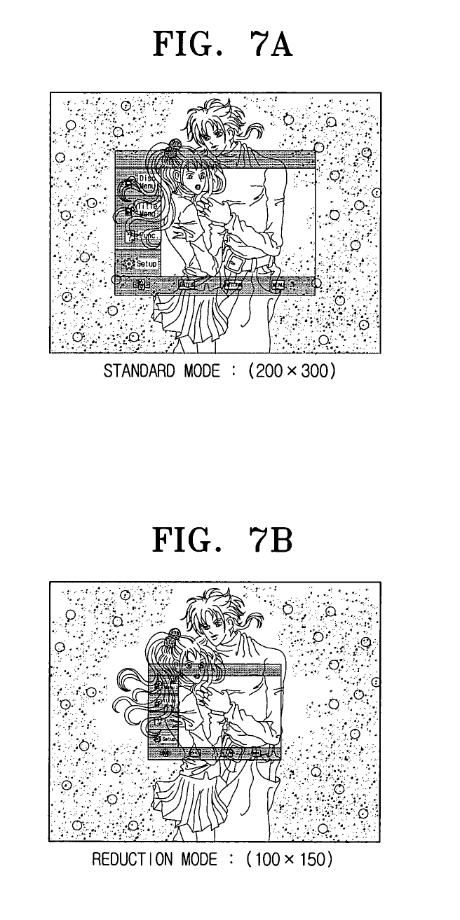

If the display device 300 with the large-sized screen is connected to the optical reproducing apparatus 200 and the menu view is displayed large as shown in FIG. 7A, the user can minimize the menu view by using the reduction mode as shown in FIG. 7B. By reducing the size of the menu view occupying considerable areas on the display device 300, it is possible to remedy the discomfort a user may feel while watching the video being reproduced.

In the light of the foregoing, it is possible to adjust the size of the menu view according to the screen size of the display device 300 that is connected to the optical reproducing apparatus 200. Specifically, the user can obtain a desired size of the menu view by adjusting the number of pixels of the menu view. Hence, as the menu view is magnified and displayed on the large-sized screen with the size of the menu view reduced, it is possible to prevent the menu view from concealing the screen.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical reproducing apparatus capable of adjusting a size of a menu view, comprising:
a user input unit to select a predetermined menu view mode among a plurality of menu view modes displaying a standard menu view in different sizes;
a storage to store an image information of the standard menu view corresponding to a standard mode among the plurality of the menu view modes;
a menu view generator to generate a menu view corresponding to the predetermined menu view mode selected by the user input unit based on the stored image information;
an output unit to output the generated menu view to a display device; and
a controller to control the menu view generator to adjust a size of the standard menu view based on the image information if the selected menu view mode is one of an enlargement mode and/or a reduction mode.

2. The optical reproducing apparatus of claim 1, wherein the controller controls the menu view generator to enlarge the size of the standard menu view by increasing a number of pixels of the standard menu view in at least one of a horizontal direction and/or a vertical direction if the selected menu view mode is the enlargement mode.

3. The optical reproducing apparatus of claim 1, wherein the controller controls the menu view generator to reduce the size of the standard menu view by decreasing a number of pixels of the standard menu view in at least one of the horizontal direction and/or the vertical direction if the selected menu view mode is the reduction mode.

4. The optical reproducing apparatus of claim 1, wherein the image information contains a number of pixels of the standard menu view and a font set corresponding to the standard menu view.

5. The optical reproducing apparatus of claim 1, further comprising:
an optical disc drive to detect data recorded on an optical disc by irradiating light on the optical disc;
a digital signal processor to digitize the detected data; and
a reproduction processor to process the digitized data into a reproducible signal and to output the reproducible signal to the output unit,
wherein the controller controls the reproduction processor to overlap and output to the output unit the menu view generated in the menu view generator over a video signal included in the reproducible signal.

6. An optical reproducing method capable of adjusting a size of a menu view, comprising:
storing an image information of a standard menu view;
selecting by a user interface a certain menu view mode among a plurality of menu view modes displaying the standard menu view in different sizes;
generating a menu view corresponding to the selected menu view mode, if the selected menu view mode is one of an enlargement mode or a reduction mode, by adjusting a size of the standard menu view based on the stored image information; and
outputting the generated menu view to a display device.

7. The optical reproducing method of claim 6, further comprising:
enlarging the size of the standard menu view by increasing a number of pixels of the standard menu view in at least one of a horizontal direction and/or a vertical direction if the selected menu view mode is the enlargement mode.

8. The optical reproducing method of claim 6, further comprising:
reducing the size of the standard menu view by decreasing the number of pixels of the standard menu view in at least one of the horizontal direction and/or the vertical direction if the selected menu view mode is the reduction mode.

9. The optical reproducing method of claim 6, wherein the image information contains the number of pixels of the standard menu view and a font set corresponding to the standard menu view.

10. The optical reproducing method of claim 6, further comprising, before outputting the generated menu view:
detecting data recorded on an optical disc by irradiating light on the optical disc;
digitizing the detected data;
processing the digitized data into a reproducible signal; and
overlapping the generated menu view over a video signal included in the reproducible signal.

11. An optical reproducing method, comprising:
generating a menu view corresponding to a selected menu view mode, including an enlargement mode or a reduction mode, by adjusting a size of a standard menu view based on corresponding stored image information.

12. The optical reproducing method of claim 11, further comprising:
enlarging the size of the standard menu view by increasing a number of pixels of the standard menu view in at least one of a horizontal direction and/or a vertical direction if the selected menu view mode is the enlargement mode.

13. The optical reproducing method of claim 11, further comprising:
reducing the size of the standard menu view by decreasing the number of pixels of the standard menu view in at least one of the horizontal direction and/or the vertical direction if the selected menu view mode is the reduction mode.
